(19) United States
(12) Patent Application Publication
(10) Pub. No.: US 2020/0192053 A1
(43) Pub. Date: Jun. 18, 2020

(54) LENS ASSEMBLY FOR AN IMAGE DETECTION DEVICE FOR A VEHICLE, IMAGE DETECTION DEVICE, AND METHOD FOR MANUFACTURING AN IMAGE DETECTION DEVICE

(71) Applicant: Robert Bosch GmbH, Stuttgart (DE)

(72) Inventor: Peter Diesel, Bad Hindelang (DE)

(21) Appl. No.: 16/710,806

(22) Filed: Dec. 11, 2019

(30) Foreign Application Priority Data
Dec. 18, 2018 (DE) 102018222192.8

(51) Int. Cl. G02B 7/02

(52) U.S. Cl. CPC G02B 7/025; B60R 11/04; G02B 7/021

(57) ABSTRACT

A lens assembly for an image detection device of a vehicle. The image detection device includes a retaining element that is situated on a sensor carrier. The lens assembly includes a barrel for accommodating at least one lens, and at least one wing contour that is fastened to the barrel. The wing contour is shaped to encompass a retaining element, at least in sections, when the lens assembly is mounted on the retaining element. The wing contour includes a bonding area for an adhesive bond between the wing contour and the retaining element.

### RELATED APPLICATION INFORMATION

The present application claims priority to and the benefit of German patent application no. DE 10 2018 222 192.8, which was filed in Germany on Dec. 18, 2018, the disclosure of which is incorporated herein by reference.

### FIELD OF THE INVENTION

The present invention is directed to a lens assembly for an image detection device for a vehicle, an image detection device, and a method for manufacturing an image detection device.

### BACKGROUND INFORMATION

Image detection devices are being increasingly used in the automotive sector in order to allow the customer to have what may be a comfortable driving experience.

### SUMMARY OF THE INVENTION

In light of this background, the approach presented here provides an improved lens assembly for an image detection device for a vehicle, an improved image detection device, and an improved method for manufacturing an image detection device. Advantageous refinements and enhancements of the device stated herein are possible as a result of the measures set forth in the further descriptions herein.

With the approach presented here, a lens assembly of the image detection device may be permanently and reliably held at a position within the image detection device. A radial adhesive bond may be advantageously used.

The image detection device for a vehicle includes a sensor carrier and a retaining element, situated on the sensor carrier, for a lens assembly. Such a lens assembly includes a barrel and at least one wing contour that is fastened to the barrel. The barrel is shaped to accommodate at least one lens. The at least one wing contour is shaped to encompass the retaining element, at least in sections, when the lens is mounted on the retaining element. The wing contour includes a bonding area for an adhesive bond between the wing contour and the retaining element.

The image detection device may be implemented, for example, as a camera which may be mounted in a vehicle. The vehicle may be configured, for example, to transport persons and/or objects, and may be a road vehicle. According to one specific embodiment, the barrel, also referred to as the lens barrel, may have an internal cylindrical shape, so that one or multiple lenses may be situated in its interior. According to one specific embodiment, at least one lens is situated in the barrel. The wing contour may, for example, be affixed to the outer wall of the barrel in an integrally joined manner, or be a one-piece component manufactured in the injection molding process or a similar process. The wing contour may then be manufactured from the same material as the barrel. The retaining element may have the function of a guide element for the lens assembly so that the lens assembly may be precisely positioned, for example. When the image detection device is mounted, one end of the barrel may be inserted into an area enclosed by the retaining element, and with the aid of the adhesive bond may be integrally joined to the retaining element. Due to the fact that the wing contour encompasses the retaining element at least in sections, the adhesive bond may be configured as a radial adhesive bond. In this case, in the mounted state of the lens assembly a section of the retaining element may be situated between the bonding area of the wing contour and the barrel. Adhesive may be applied to both the inner side and the outer side of the retaining element in order to achieve a radial adhesive bond in each case.

According to one specific embodiment, the configuration of the interface between the retaining element and the lens assembly is selected in such a way that the bonding area is under compression stress under the operating conditions. Adhesive bonds under compression stress are much more robust with regard to the failure behavior than under tensile stress.

According to one specific embodiment, the wing contour may include a web that is fastened to the barrel, and an arm that is situated on a free end of the web. The web may span the retaining element, and the arm may overlap the retaining element, at least in sections, when the lens assembly is mounted on the retaining element. A very stable radial adhesive bond between the barrel and the retaining element may be achieved in this way.

According to one specific embodiment, the web may be oriented radially with respect to an axial longitudinal axis that extends through the barrel. The arm may be oriented in parallel to the axial axis. The longitudinal axis may extend in the z direction. This means that the web may be situated at a right angle to the barrel, and the arm may be oriented at a right angle to the web. The retaining element may advantageously be reliably enclosed in a space-saving manner due to the right-angled design of the wing element.

According to one specific embodiment, the arm on a surface facing the barrel may include the bonding area for the adhesive bond between the wing contour and a surface of the retaining element facing away from the barrel. A radial adhesive bond may be achieved in this way. In addition, an adhesive that is used for the adhesive bond may be prevented from contacting the image sensor.

According to one specific embodiment, the height of the web of the wing contour may be less than a distance between the barrel and the arm of the wing contour.

For this purpose, more space is advantageously provided for positioning the lens assembly. Alternatively, the height of the web may be greater than a distance between the barrel and the arm. The stability of the image detection device may be advantageously increased in this way.

According to one specific embodiment, the lens assembly may be made of plastic. The lens assembly may also be referred to as the lens barrel, which may enclose the barrel together with the web and the arm. The retaining element may be made of metal.

Manufacturing costs for the lens assembly and the retaining element as well as mechanical advantages of the retaining element made of metal may advantageously be utilized by the selection of the material.

According to one specific embodiment, the lens assembly may include a plurality of wing contours that are radially distributed around the barrel. The stability of the image detection device may be increased by using multiple wing contours. For example, two, three, four, five, six, or more wing contours may be used.

Such an image detection device for a vehicle includes a sensor carrier, an image sensor that is situated on the sensor carrier, a retaining element that is situated on the sensor carrier, and a lens assembly as mentioned (a lens barrel with optical and mechanical elements) that is situated opposite from the image sensor; the lens assembly and the retaining element are joined via the adhesive bond.

The image detection device may be configured as a camera, for example. The sensor carrier may be configured, for example, as a circuit board, a conductor board, or a so-called “stiffener,” i.e., a reinforcing element made of metal, ceramic, or other suitable materials. The image sensor and the retaining element may be situated on the sensor carrier. The image sensor may be a sensor as customarily used in image detection devices such as a camera. The image sensor may be situated in an area that is bordered by the retaining element. The retaining element may advantageously be formed as a circumferential wall. The lens assembly may be placed on an end of the retaining element facing away from the sensor carrier. For suitable optical imaging of the surroundings, the lens assembly must be positioned (aligned) with respect to the image sensor within narrow geometric limits. The adhesive bond between the retaining element and the lens assembly is suitable for this purpose to ensure the tolerance compensation of the involved components. The image detection device may be used, for example, to detect images of objects situated inside or outside of the vehicle. Image data provided by the image detection device may be used, for example, for a driving assistance function of the vehicle.

A method for manufacturing an image detection device as mentioned includes the following steps:

providing a sensor carrier on which an image sensor and a retaining element are situated;
providing a lens assembly as mentioned;
inserting and positioning the lens assembly in the retaining element; and
establishing the adhesive bond with the aid of an adhesive in order to affix the lens assembly to the retaining element in the correct position.

The lens assembly provided in the step of providing may include a lens barrel and optical and mechanical components. According to one specific embodiment, a curable adhesive may be used as adhesive in the step of establishing. It is advantageously not necessary to mechanically process the components to be joined in order to affix them to one another.

According to one specific embodiment, the adhesive may be cured by UV curing and/or thermal curing, for example. The UV curing may refer to a process in which reactive materials are converted from a viscous state into a solid state with the aid of electromagnetic radiation of a suitable wavelength. According to one specific embodiment, this means that the adhesive is cured with the aid of UV radiation. Thermal curing describes a hardening process in which the adhesive becomes hard by heating.

According to one specific embodiment, a curing temperature may be greater than a predetermined operating temperature of the image detection device. In this way, the manufacturing conditions and the operating conditions of the image detection device may be coordinated with one another.

Exemplary embodiments of the approach presented here are illustrated in the drawings and explained in greater detail in the following description.

In the following description of advantageous exemplary embodiments of the present invention, identical or similar reference numerals are used for the elements having a similar action which are illustrated in the various figures, and a repeated description of these elements is dispensed with.

### BRIEF DESCRIPTION OF THE DRAWINGS

FIG. 1 shows a schematic cross-sectional illustration of an image detection device that includes a lens assembly for a vehicle according to one exemplary embodiment, with adhesive.

FIG. 2 shows a schematic cross-sectional illustration of an image detection device that includes a lens assembly for a vehicle according to one exemplary embodiment, with a schematic illustration of the mechanical shrinkage properties due to cooling after the thermal curing.

FIG. 3 shows a schematic cross-sectional illustration of an image detection device that includes a lens assembly for a vehicle according to one exemplary embodiment, without adhesive.

FIG. 4 shows a schematic cross-sectional illustration of an image detection device that includes a lens assembly for a vehicle according to one exemplary embodiment, with a schematic illustration of the mechanical shrinkage properties due to cooling after the thermal curing, without adhesive.

FIG. 5 shows a schematic illustration of an image detection device that includes a lens assembly for a vehicle according to one exemplary embodiment, with adhesive.

FIG. 6 shows a schematic illustration of an image detection device that includes a lens assembly for a vehicle according to one exemplary embodiment, with a schematic illustration of the mechanical shrinkage properties due to cooling after the thermal curing, with adhesive.

FIG. 7 shows a flow chart of a method for manufacturing an image detection device according to one exemplary embodiment.

### DETAILED DESCRIPTION

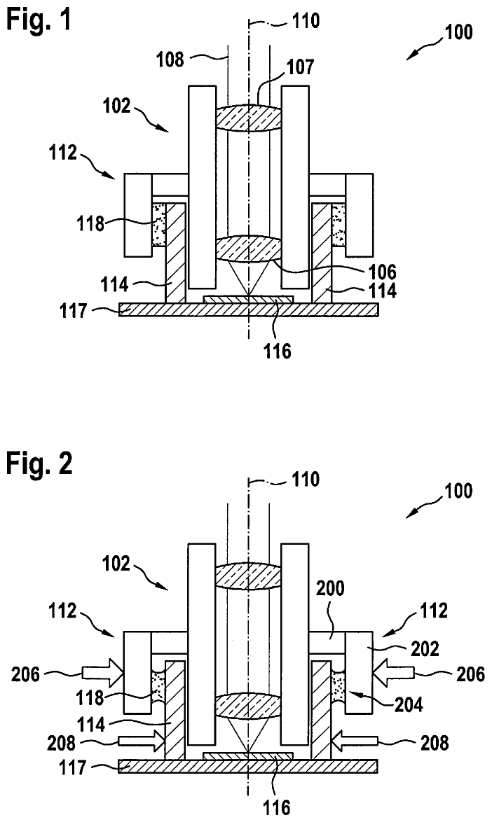

FIG. 1 shows a schematic cross-sectional illustration of an image detection device 100 that includes a lens assembly 102 for a vehicle according to one exemplary embodiment. The vehicle may, for example, be suitable for transporting persons and/or objects. Alternatively, image detection device 100 may be used for some other field of application, for example on a building.

According to one exemplary embodiment, image detection device 100 is configured as a camera that is usable, for example, as a parking assistant, for sign recognition, or also for other functions within the vehicle. Lens assembly 102 of image detection device 100 includes a barrel 104, in which according to this exemplary embodiment at least one lens 106, 107 is already situated. As an example, barrel 104 is shown with two lenses 106, 107 that are situated in a row in a light path. For example, lens 106 is configured to focus a light beam 108 that extends in parallel to an axial longitudinal axis 110 of barrel 104.

Lens assembly 102 includes a wing contour 112 that is fastened to barrel 104. By use of wing contour 112, lens assembly 102 may be connected to a retaining element 114 that is situated on a sensor carrier 117 that supports an image sensor 116. For this purpose, wing contour 112 is shaped to encompass retaining element 114, at least in sections. Retaining element 114 is shaped to correctly hold lens assembly 102 at a suitable position above image sensor 116 of image detection device 100. For this purpose, retaining element 114 forms a cylindrical wall, for example, that surrounds image sensor 116.

In FIG. 1, image detection device 100 is in an operationally ready state in which lens assembly 102 is fixed to retaining element 114. In this state, retaining element 114 and wing contour 112 are joined together via an adhesive bond 118 that is configured as a radial adhesive bond.

As a result of adhesive bond 118, a radial adhesive bond of lens assembly 102 to retaining element 114, which is used as a lens holder, is achieved under compression stress under the intended operating conditions. For this purpose, the material properties and the curing conditions are selected in such a way that the adhesive bond is under compression stress in the field of application. The compression load that arises is advantageous, since with regard to failure of a bonding site, compression loads are less harmful than tensile loads. By use of retaining element 114, lens assembly 102 is positioned very precisely with respect to image sensor 116 so that suitable imaging may be obtained from image sensor 116. Retaining element 114 represents the geometric connection of the normally radially symmetrical lens barrel, also referred to as a barrel 104, with respect to sensor carrier 117, to sensor 116. Sensor 116 is oriented perpendicularly with respect to the optical axis of lens assembly 102. Due to adhesive bond 118, lens assembly 102 may be joined to retaining element 114 without a screw connection, for which barrel 104 and retaining element 114 would need matching threads. The gluing still allows fine adjustment of lens assembly 102 with respect to image sensor 116. A 5-axis orientation of lens assembly 102 may be carried out. The adhesion that results in adhesive bond 118 may then compensate for the manufacturing tolerances of the parts and the structure. This interface may thus be used for tolerance compensation for the part tolerances and the manufacturing tolerances. The load on the bonding sites is a function of the materials used, the geometries, the manufacturing conditions, and the operating conditions for the product.

According to one alternative exemplary embodiment, adhesive bonds that are used have a mixed axial and radial configuration, depending on the geometry of the parts used, so that axial adhesive bonds and radial adhesive bonds may be used. In addition, the connection of sensor carrier 117 to retaining element 114 may additionally take place with the aid of a screw connection when retaining element 114 and sensor carrier 117 for this purpose have matching contours, boreholes, or other geometric features that allow a screw connection.

According to one exemplary embodiment, barrel 104 and wing contour 112 are made of plastic. In one alternative exemplary embodiment, barrel 104 and wing contour 112 may be made of metal. According to one exemplary embodiment, retaining element 114 is made of metal, in one alternative exemplary embodiment it being possible for the retaining element to be made of some other material such as plastic.

According to one exemplary embodiment, barrel 104 and additionally or alternatively retaining element 114 are/is plated with metal, for example brass or aluminum, with the advantages of precise processing and isotropic mechanical properties. Different materials and processes, as well as different configurations of surfaces, may be used for manufacturing barrel 104 from metal, which advantageously allows a favorable manufacturing process and suitable mechanical properties.

Alternatively, barrel 104 and additionally or alternatively retaining element 114 are/is made of plastic. Different materials, processes, and surfaces may be used. The advantage of plastic is a favorable manufacturing process and resulting suitable mechanical properties and anisotropic mechanical properties.

Using radial adhesive bonds for joining a barrel 104 to a retaining element 114 is also not a problem when a retaining element 114 made of metal and a barrel 104 made of plastic are used, since wing contour 112 is geometrically formed in such a way that adhesive bond 118 is structurally held under compression stress. In principle, the system at the start of curing is mechanically relaxed, since the adhesive compensates for tolerances that are present. This means that lens assembly 102 and retaining element 114 undergo maximum thermal expansion, and the adhesive is not yet thermally shrunk. After the curing, lens assembly 102 and retaining element 114 have undergone maximum thermal shrinkage. However, the shrinkage of retaining element 114 is less than that of barrel 104. The adhesive is thermally shrunk. According to exemplary embodiments, the barrel configuration and the retaining element configuration are modified in such a way that the adhesive bond remains under compression stress in the field of application, without losing the cost advantages of a plastic barrel as well as the cost and mechanical advantages of retaining element 114 made of metal.

In one configuration of barrel 104, lens assembly 102 together with plastic barrel 104 is subjected to maximum shrinkage after the curing and cooling to a very low operating temperature, for example −40° C. (the coefficient of expansion is greater than for metal). Retaining element 114 is subjected to maximum shrinkage (the coefficient of expansion is less than for plastic, as the result of which a small coefficient of expansion is needed in order to make small displacements in the z direction). According to one exemplary embodiment, the adhesive is subjected to maximum shrinkage on account of the UV precuring, and due to volumetric shrinkage as a result of the curing and due to thermal shrinkage. The adhesive attempts to geometrically counteract the volumetric shrinkage by forming a meniscus. However, this is possible only to a limited extent, since the adhesive mechanically hardens during the curing. In the process, the adhesive absorbs the geometric mismatch of lens assembly 102 and retaining element 114 as compression stress. Barrel 104 may additionally absorb compression stresses by mechanical yielding of wing contours 112. The adhesive thereby also absorbs the geometric mismatch due to the cooling of the geometries of lens assembly 102 and retaining element 114 as compression stress. The adhesive is not harmed by the absorption of compression stresses in the interior and on the contact surfaces of the bonding partners. Since internal stresses do not reach the level of the tensile strength of the adhesive, the adhesive does not internally rupture, and the adhesion stresses at the contact surfaces are not exceeded. Thus, the adhesive does not separate from the surface, and the adhesive bond is not weakened.

Likewise, the maximum possible compression stresses of the adhesive and of the contact areas are not exceeded. This must be taken into consideration in the configuration of the bonding site. The cost advantages of barrel 104 made of plastic and the cost and mechanical advantages of retaining element 114 made of metal are maintained.

According to one exemplary embodiment, the adhesive bond is held under compression stress under the operating conditions (T_{operating conditions}<T_{curing}) The combination for curing is thus above the operating temperature. This is desirable in order to not trigger thermal post-curing under the operating conditions, which could change the positioning of image sensor 116 with respect to the focusing cap of lens assembly 102. The system experiences maximum expansion at the time of thermal curing. The adhesive becomes solid under the curing conditions. Upon cooling, the joining partners shrink, with plastic barrel 104 shrinking more than metal retaining element 114. The adhesive bond is thus subjected to compression stress. Penetration of moisture into the adhesive typically causes it to swell. This likewise generates compression stresses. A tensile stress configuration is not achieved. In terms of adhesion and cohesion, the adhesive is more mechanically robust under compression stresses than under tensile stresses. A material or wetting demolition of the adhesive is thus avoided.

According to one exemplary embodiment, barrel 104 is still made of plastic. This allows a cost-effective lens assembly 102. A lens assembly 102 configured as an automotive lens assembly, for example, may be configured with a metal barrel 104 or with a plastic barrel 104. Metal barrels 104 are more expensive, since mechanical fine machining (precision of lens assembly 102) and a coating, which is typically black, are necessary to minimize scattered light effects in the beam path. A lens assembly 102 with a metal barrel 104 may be closed off by a crown or retainer ring, which is also expensive. Plastic barrels 104 are more cost-effective since they may be manufactured in the injection molding process, and the blackening is already present in the material. However, achieving mechanical precision places high demands on injection molding. Plastic barrels 104 may be closed off in a cost-effective manner using hot deformation processes, for example.

According to one exemplary embodiment, retaining element 114 is still configured as a metal part. This allows a good balance between costs and a low coefficient of expansion in the z direction. Slight thermal expansion of retaining element 114 in the z direction is necessary to keep the positioning of the focusing cap of lens assembly 102 in the sensor plane. This may be achieved using stainless steel retaining elements 114, for example. These may be cost-effectively manufactured using deep drawing technology. Another option for a z shift correction is a suitable configuration for the lens, which compensates for the temperature response of the structure. However, this compensation is then dependent on the imager module configuration, which is economical for lens manufacturers only with a very high production volume of lens assemblies 102.

According to one exemplary embodiment, the mechanical spring behavior of the at least one wing contour 112 is used to relieve the additional input of compression stress into the adhesive bond. If barrel 104 is configured in such a way that wing contours 112 are able to yield radially under load, there is the option to divert further compression stresses, due to moisture swelling of the adhesive, into the at least one wing contour 112 so that the adhesive bond itself is not overloaded by compression stress. However, making use of such a property requires a detailed configuration of the barrel and wing contour, as well as very precise introduction of the adhesive at the appropriate positions.

FIG. 2 shows a schematic cross-sectional illustration of an image detection device 100 that includes a lens assembly 102 for a vehicle according to one exemplary embodiment. Image detection device 100 corresponds to image detection device 100 described in FIG. 1; FIG. 2 illustrates forces acting on adhesive bond 118.

According to one exemplary embodiment, lens assembly 102 includes multiple separate wing contours 112 situated around barrel 104 on the outer wall of barrel 104. The cross-sectional illustration in FIG. 2 shows two of these wing contours 112. Alternatively, a circumferential wing contour 112 may be used.

Wing contours 112 each include a web 200 and an arm 202. Web 200 spans a wall section of retaining element 114 in the area of wing contour 112. The length of web 200 is thus greater than a thickness of a wall of retaining element 114. Arm 202 of the wing contour, starting from a free end of web 200, extends in the direction of sensor carrier 117. According to one exemplary embodiment, arm 202 is oriented in parallel to longitudinal axis 110. Arm 202 partially overlaps retaining element 114, so that an end section of arm 202 is situated opposite from and in parallel to an end section of retaining element 114. In the overlap area, arm 202 on a side facing retaining element 114 includes a bonding area 204 to which the adhesive of adhesive bond 118 is applied. Adhesive bond 118 of a wing contour 112 is thus situated between an outer side of retaining element 114 in the area of wing contour 112 and arm 202 of wing contour 112 in relation to a transverse axis oriented transversely with respect to longitudinal axis 110. Similarly, retaining element 114 is situated between an outer side of barrel 104 in the area of wing contour 112 and retaining element 114 in the area of wing contour 112 in relation to the transverse axis.

According to one exemplary embodiment, image detection device 100 shown in FIG. 2 is illustrated after a curing operation during which the material of image detection device 100 performs mechanical work when it is cooled from a high temperature to a lower temperature. Since it is known that materials expand at high temperatures and contract at low temperatures, this property may be utilized during the curing operation to fix lens assembly 102 to retaining element 114. The adhesive, which is placed between arm 202 and retaining element 114 for adhesive bond 118, thus creates tension during the curing operation. According to one exemplary embodiment, the tension is created by the material of image detection device 100 performing work in arrow directions 206, 208. Since according to this exemplary embodiment the individual components of image detection device 100 are made of different materials, the materials respond differently to a change in temperature. As a result, the adhesive of adhesive bond 118 is forced to deform. Tension builds up in adhesive 204, radially with respect to axial axis 110, when, for example, retaining element 114 contracts more strongly than arm 202 of lens assembly 102.

In the exemplary embodiment illustrated in FIG. 2, webs 200 of wing contours 112 have a thin configuration. For example, the height of webs 202 in the direction of longitudinal axis 110 is less than a distance between barrel 104 and arms 202.

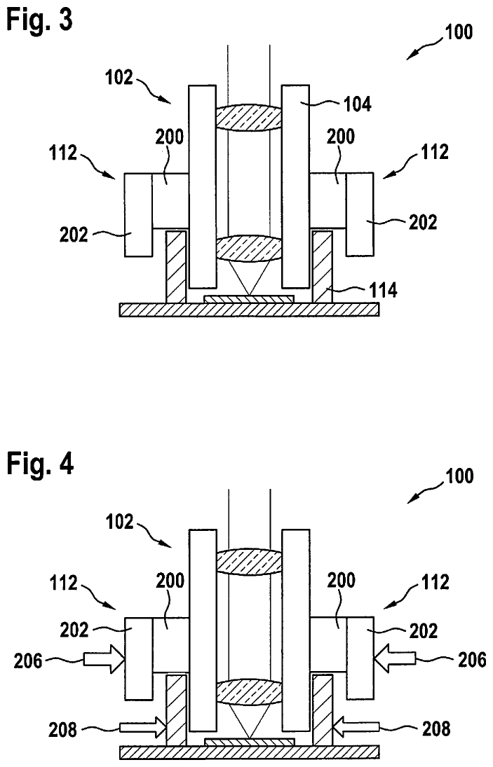

FIG. 3 shows a schematic cross-sectional illustration of an image detection device 100 that includes a lens assembly for a vehicle according to one exemplary embodiment. Image detection device 100 corresponds to image detection device 100 described with reference to FIGS. 1 and 2; the adhesive bond is not illustrated, and webs 200 of wing contours 112 have a thick configuration. For example, the height of webs 202 is greater than a distance between barrel 104 and arms 202.

FIG. 4 shows a schematic cross-sectional illustration of image detection device 100 shown in FIG. 3, with the material changes that result during curing of the adhesive bond, which are indicated by arrow directions 206, 208. The mechanical shrinkage properties due to cooling after the thermal curing, without adhesive, are schematically illustrated. A compression stress that acts on the adhesive bond builds up during the curing when an outer diameter of retaining element 114 shrinks less than an outer diameter of lens assembly 102 in the area of arms 202 of wing contours 112.

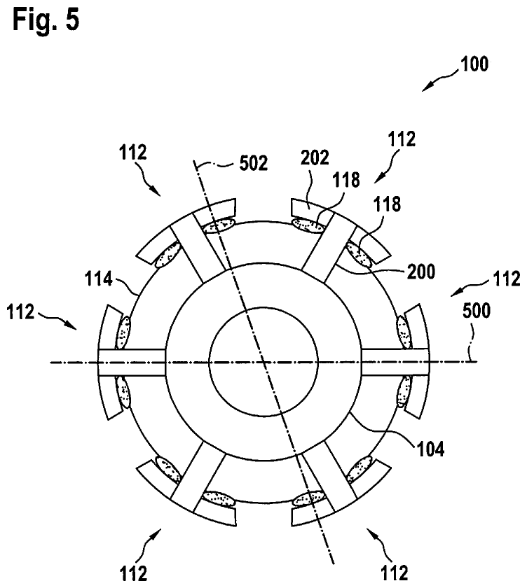

FIG. 5 shows a schematic illustration of an image detection device 100 according to one exemplary embodiment. This may be an exemplary embodiment of image detection device 100 shown with reference to the preceding figures, but which in FIG. 5 is illustrated from the top view. In the top view it is apparent that image detection device 100 has a circular shape with a cylindrical barrel 104 and a cylindrical retaining element 114. In the manufactured state shown in FIG. 5, retaining element 114 and wing contours 112 are joined by adhesive.

The outer diameter of barrel 104 is adapted to the inner diameter of retaining element 114 so that barrel 104 is accommodated by retaining element 114 with what may be very little play. Retaining element 114 is configured to impart stability to barrel 104, and at the same time to hold it in a suitable position. However, enough radial play must still be present to ensure tolerance compensation for suitably positioning the lens assembly with respect to the sensor.

According to one exemplary embodiment, multiple wing contours 112 are situated on barrel 104. As an example, six wing contours 112 are situated around barrel 104, with wing contours 112 situated in a plane. Each of wing contours 112 is formed by a web 200 and an arm 202. The longitudinal axes of webs 200 are oriented radially with respect to a longitudinal axis of barrel 104. According to this exemplary embodiment, arms 202 have a greater width than webs 200, so that wing contours 112 have a T-shaped cross section. According to one exemplary embodiment, arms 202 have a curvature, so that a gap between arms 202 and retaining element 114 is essentially constant over the entire width of arms 202.

An adhesive bond 118 is situated between each arm 202 and retaining element 114. According to the exemplary embodiment shown, webs 202 of oppositely situated wing contours 112 are situated on a shared web axis 500, which denotes a web area. The adhesive bonds 118 of oppositely situated wing contours 112 are similarly situated on a shared adhesive axis 502, which denotes an adhesive area.

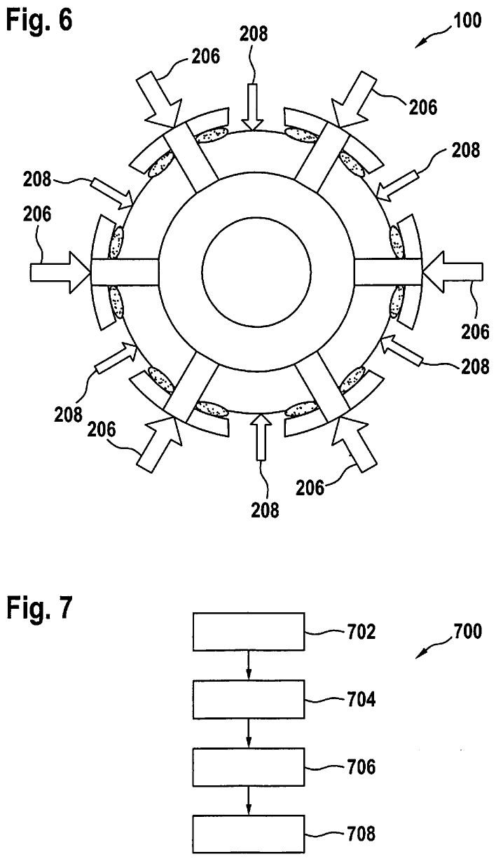

FIG. 6 shows a schematic illustration of image detection device 100, already shown in FIG. 5, according to one exemplary embodiment with a schematic illustration of the mechanical shrinkage properties due to cooling after the thermal curing, with adhesive. Arrows 206, 208 indicate the above-described material changes that occur during the curing.

FIG. 7 shows a flow chart of a method 700 for manufacturing an image detection device for a vehicle. This may be an image detection device as described with reference to the preceding figures. Method 700 allows a lens to be radially affixed to a retaining element.

A sensor carrier on which an image sensor and a retaining element are situated is provided in a step 702. A lens assembly as described with reference to the preceding figures is provided in a step 704. According to different exemplary embodiments, the barrel of the lens assembly may include at least one lens or no lens. The lens assembly is inserted into the retaining element and positioned in a step 706, and an adhesive bond is established with the aid of an adhesive in a step 708. As a result of the adhesive bond, the lens assembly is correctly affixed at the intended position on the retaining element. The adhesive may be cured, for example using UV radiation or thermal energy input, in step 708 of establishing. According to one exemplary embodiment, the curing temperature that acts on the adhesive during the curing is greater than a predetermined maximum operating temperature of the image detection device. For example, if the curing temperature is 125° C. or greater, it is advantageous for the operating temperature to be at most 120° C. If the lens assembly is provided without a lens in step 704, at least one lens may optionally be inserted into the barrel of the lens assembly after carrying out step 708.

If an exemplary embodiment includes an “and/or” linkage between a first feature and a second feature, this may be construed in such a way that according to one specific embodiment, the exemplary embodiment has the first feature as well as the second feature, and according to another specific embodiment, the exemplary embodiment either has only the first feature or only the second feature.

What is claimed is:

1. A lens assembly for an image detection device, which includes a retaining element situated on a sensor carrier, for a vehicle, comprising:
a barrel shaped to accommodate at least one lens; and
at least one wing contour fastened to the barrel and shaped to encompass the retaining element, at least in sections, when the lens assembly is mounted on the retaining element;
wherein the wing contour includes a bonding area for an adhesive bond between the wing contour and the retaining element.

2. The lens assembly of claim 1, wherein the wing contour includes a web fastened to the barrel, and an arm that is situated on a free end of the web, the web spanning the retaining element, and the arm overlapping the retaining element, at least in sections, when the lens assembly is mounted on the retaining element.

3. The lens assembly of claim 2, wherein the web is oriented radially with respect to an axial axis that extends through the barrel, and the arm is oriented in parallel to the axial axis.

4. The lens assembly of claim 2, wherein the arm on a surface facing the barrel includes the bonding area for the adhesive bond between the wing contour and a surface of the retaining element facing away from the barrel.

5. The lens assembly of claim 2, wherein the height of the web is less than a distance between the barrel and the arm.

6. The lens assembly of claim 2, wherein the height of the web is greater than a distance between the barrel and the arm.

7. The lens assembly of claim 1, wherein the lens assembly is made of plastic and the retaining element is made of metal.

8. The lens assembly of claim 1, wherein the lens assembly includes a plurality of wing contours that are radially distributed around the barrel.

9. An image detection device for a vehicle, comprising:
a sensor carrier;
an image sensor situated on the sensor carrier;
a retaining element situated on the sensor carrier; and
a lens assembly situated opposite from the image sensor, the lens assembly and the retaining element being joined via the adhesive bond;
wherein the lens assembly includes:
a barrel shaped to accommodate at least one lens; and
at least one wing contour fastened to the barrel and shaped to encompass the retaining element, at least in sections, when the lens assembly is mounted on the retaining element;
wherein the wing contour includes a bonding area for the adhesive bond between the wing contour and the retaining element.

10. A method for manufacturing an image detection device for a vehicle, the method comprising:
providing a sensor carrier on which an image sensor and a retaining element are situated;
providing a lens assembly;
inserting and positioning the lens assembly in the retaining element; and
establishing the adhesive bond with an adhesive to affix the lens assembly to the retaining element in the correct position;
wherein the lens assembly includes:
a barrel shaped to accommodate at least one lens; and
at least one wing contour fastened to the barrel and shaped to encompass the retaining element, at least in sections, when the lens assembly is mounted on the retaining element;
wherein the wing contour includes a bonding area for the adhesive bond between the wing contour and the retaining element.

11. The method of claim 10, wherein the adhesive is cured in the establishing.

12. The method of claim 11, wherein a curing temperature is greater than a predetermined operating temperature of the image detection device.

13. The method of claim 10, wherein the adhesive is cured, by UV curing or thermal curing, in the establishing.
